(19) United States
(12) Patent Application Publication
(10) Pub. No.: US 2021/0342751 A1
(43) Pub. Date: Nov. 4, 2021

(54) System and Method for Monetizing Underused Assets

(71) Applicant: Christina COX, Farmers Branch, TX (US)

(72) Inventor: Christina COX, Farmers Branch, TX (US)

(21) Appl. No.: 17/035,434

(22) Filed: Sep. 28, 2020

Related U.S. Application Data
(60) Provisional application No. 62/878,995, filed on Jul. 26, 2019.

(51) Int. Cl. G06Q 10/02; G06Q 30/06

(52) U.S. Cl. CPC G06Q 10/02; G06Q 30/0645

(57) ABSTRACT

A system and method for monetizing an asset. The system matches a potential renter with a property owner. The property owner can list two or more segmented properties which can be rented separately or together. This provides the property owner and opportunity to rent segments or property which were not previously monetized. The system also provides customized vendor information related to the location and event type selected by the potential renter.

### PRIORITY

The present invention claims priority to U.S. Provisional Application No. 62/878,995 filed Jul. 26, 2019, the entirety of both of which is hereby incorporated by reference.

### BACKGROUND OF THE INVENTION

### Technical Field

The present invention relates to a system and method for monetizing underused assets.

### Description of Related Art

Property owners often have several assets tied to the property. Unfortunately, however, the housing structure is typically the only asset which is monetized through leasing or rental. Consequently, there is a need for a way to allow property owners to monetize the various property segments.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram of an embodiment of the present hosting system;

FIG. 2 is a flow chart of a client posting a property in one embodiment;

FIG. 3 is a flow chart of a client reserving a property in one embodiment;

FIG. 4 is a property listing in one embodiment;

FIG. 5 is a vendor listing in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

A system and method is described herein which allows potential renters to be suited with posters which have different types of property. Property, as used herein, refers to any item which can be purchased, leased, or rented. Property includes real and tangible property. As examples, property includes houses, cabins, etc. Property also includes land.

As an example, an owner can own a beach house, and the beach house also has a sandy beach. Previously, there was no mechanism by which the owner can monetize the beach apart from the house. While there are ways to rent the house, there is no currently available method to separately rent the beach. The system and method discussed herein provides that mechanism.

In one embodiment, the system and method allows a property owner to list two or more segments of a property. A segment of property, as used herein, is a smaller portion of the entire property. Thus, the guest cottage is a segment, and the main house is a segment.

The home owner, using the system and method discussed herein, can post the beach for rental or lease separate from, or in addition to the house. As an example, destination weddings are becoming very popular. A couple may desire to be wed in a specific beach but have no need to stay in the beach house. Using the system and method discussed herein, the couple can separately rent the beach segment without requiring rental of the beach house segment. This is a benefit to the couple because it allows them greater latitude in selecting a specific beach without also requiring the accompanying house. Further, it can reduce cost to the couple because they are only renting the beach as opposed to the entire house.

Similarly, this has great advantages for the home owner. The beach is an asset just as the house is an asset. The system and method discussed herein provides the home owner with an opportunity to lease, rent, or sell that asset. Taking the wedding example, if the couple did not want or could not afford the beach house, then the home owner missed out on the opportunity to rent the beach house. This is lost revenue for the home owner. If, however, the couple was allowed to simply rent the beach segment for their wedding, the home owner realizes revenue from that asset. This is revenue they would not have otherwise received.

There are hosts of properties which are not being utilized in the revenue stream. While a beach house has been described, this is for illustrative purposes only and should not be deemed limiting. Other “structure plus land” segmented properties exist, including but not limited to, farms, barns, ranches, ranch houses, cabins, mountain retreats, mountain land, etc.

Taking the farm as an example, the farm, a petting zoo, farm house, and barn are all property segments of the entire land parcel, and each can be available for rent. A first customer may only desire to rent the barn for an event. A second customer may only want to rent the farm's petting zoo for a child's birthday, while a third customer wants to rent the farm house. Rather than waiting for the perfect customer who requires to rent the entire “farm”, the owners has multiple potential renters and, accordingly, multiple potential revenue streams.

Another example is a lake house. The lake house has a lake house, lake access, a boat dock, a bass boat, and a kayak. These are five distinct properties which can be rented. Perhaps a renter desires to rent all of the properties. A different renter, however, may only want the lake access, and the bass boat. Still a different renter only wants lake access and a kayak. Previously these properties were tied together in an “all-or-none” relationship. The system and method discussed herein allows the property owner and renter to decouple the properties to allow for more customization and more efficient utilization of assets.

As the lake house example demonstrated, the properties do not have to be land. As noted, the properties can include items such as a kayak, boat, ATV, tractor, animals, horse, etc.

In another embodiment, as will described in more detail below, the system is also coupled to a vendor database. Thus, once a renter selects a particular property, they can be prompted to determine what kind of venue will be hosted at that property. Based on the renter's input, the renter can be provided a list of relevant vendors which may have services or additional properties which may be relevant to the venue. The renter does not have to select any vendors, and not all embodiments include the vendor option, however, the vendor selection is value added to the renter.

Take a wedding as an example. If the renter selects a beach, and then a wedding, there are a host of vendors and properties that the renter may need. The renter may need a caterer, a baker for a wedding cake, a wedding officiant, chairs, tables, designers, hair and makeup services, etc. These needs can be compounded by a renter who is selecting a venue for a destination wedding. If a couple from Texas is getting married on a Florida beach, they may not know the area, the caterers, etc. By knowing the location, date, and type of the event, the system can search the vendor database to couple properties, services, and vendors with a renter. This elevates the service from a service which allows a house to be rented to a possible one-stop-shop for many of the venue needs.

Elaborating the above with the lake house example, the renter which rents the bass boat may need fishing licenses which can be provided as a vendor. Further, the renter may want a fishing guide, marina privileges, to rent other boating accessories such as skis, etc. Thus, by knowing the date, location, and type of event, the system can couple the renter with other vendors, goods, and services that might be required from the renter.

In one embodiment the vendor database can further be restricted by the host. Take, for example, a destination wedding. The beach house owner may have a set of caterers that the owner prefers. Thus, when listing the properties, the owner can select or approve vendors which can be utilized at their properties. This is a benefit to the host which allows them to restrict access to their property. It is also a benefit to the renter as the host has narrowed the list of potential vendors.

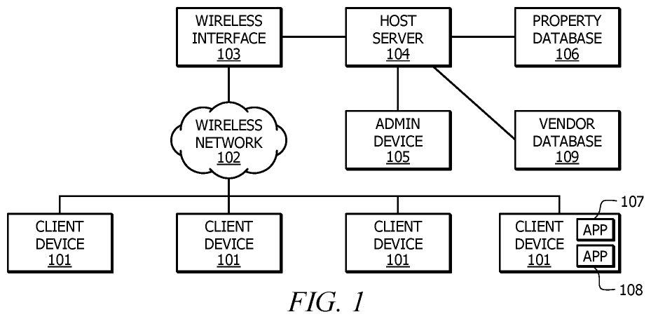

Turning now to FIG. 1, FIG. 1 is a block diagram of an embodiment of the present hosting system. As shown in FIG. 1, a plurality of client devices 101 are coupled to a wireless network 102. The hosting platform may communicate with client device 101 via known wired or wireless protocols such as WiFi, Bluetooth or other protocols.

The client device 101 can be any electronic device which allows for communication with a wireless network 102 and may include a desktop computer, portable device, smart phone, tablet or the like. The client device 101 can include a user interface 107 and a client application 108. The user interface 107 allows the user to interact with and manipulate the client device 101. The user interface 107 can comprise a touch-screen, voice-enabled technology, keypad, keyboard, mouse, etc. The client application 108 is an application which resides on either the client device 101 or a wireless network in communication with the client device 102, and allows certain operations and functionality on the client device 101.

As will be discussed herein, the client device 101 is used by various clients. A posting client, as used herein, is a client which is posting property, services, or items to be purchased, rented, or reserved by a rental client. A rental client is a client who is reviewing, researching, reserving, purchasing, renting, or leasing a property, item or service from a posting client. Thus, the client devices 101 shown in FIG. 1 can be posting clients or rental clients. As an example, one of the client devices 101 may be communicating with the hosting system to post a listing whereas one of the client devices 101 may be communicating with the hosting system to review a posting. In one embodiment, discussed herein, the hosting system provides a system and method of uniting a potential posting client with a rental client to exchange services, property, items, etc.

The wireless network 102 is in communication with the hosting systems wireless interface 103. The wireless interface 103 couples the wireless network 102 with the host server 104. The server 104 can comprise any type of computing device or server known in the art. The server 104 can communicate with databases with reside either on the server 104, or are remote from the server 104. As shown, the host server 104 communicates with a property database 106 and a vendor database 109.

Also coupled to the host server 104 is at least one administrative device 105. The administrative device 105 can comprise a desktop, smart phone, etc. The administrative device 105 comprises a user interface which allows the administrator to communicate with and control the host server 104.

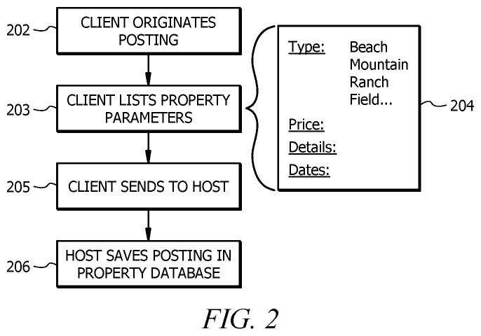

FIG. 2 is a flow chart of a client posting a property in one embodiment. In this instance, a posting client is posting a listing for a property. In doing so, the client originates a posting in step 102. The origination can take place through a client device 101. In one embodiment the client device 101 utilizes an application. In another embodiment, however, the client utilizes the hosting system's website.

Once the client posting is originated, the client is prompted to list property parameters. The property parameters are values, descriptors, and details which describe the property. As shown these can indicate the type of property, the price, dates they are available, etc. As noted herein, the system allows owners and renters to rent different types of property. As an example, a posting client can home a beach house, the beach, etc. Taking the lake house example, the posting client can list the lake house, lake access, the boat dock, the bass boat, and the kayak as separate properties.

The posting client can specify various details regarding each property, including, but not limited to, date availability, price, instructions regarding access, and other details.

Once the property parameters have been inputted by the posting client, the information is sent to the host in step 205. Thereafter the host saves the posting in a property database 106 in step 206.

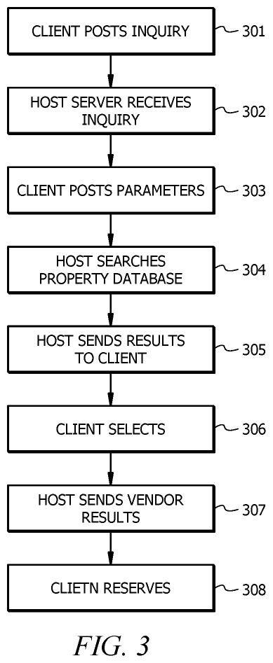

FIG. 3 is a flow chart of a client reserving a property in one embodiment. In this flow chart the rental client first posts an inquiry in step 301. As noted, this can be posted from a client device 101. The host server 104 receives that inquiry in step 302 via a wireless network 102, for example.

The client then enters the specific parameters in step 303. The client can enter these parameters on the front end, or the client can be prompted by the system. The parameters can be the same or different property parameters described above. These can include, but are not limited to, location, price range, venue type, date availability, and others. In some embodiments a first set of parameters prompts a second. As an example, if a client selects they want a beach, a second prompt may inquire if the client is interested in public beaches, private beaches, or both. Likewise, the second set may inquire as to size needs, people in attendance, whether alcohol will be served, etc.

In response to the client's parameters, the host searches the property database in step 304. The results from the property database are then sent to the client in step 305. The results can be displayed in via any fashion or method known in the art including links to web sites, table form, etc. This allows the client to browse the results from the criteria parameters provided. The client may then broaden or narrow the parameters based on the results.

After the client has reviewed the results, the client selects the property in step 306. As noted, the client can select one or more properties. Using the lake house example, the client can reserve the lake house alone, or the lake house, lake access, boat dock, and the bass boat.

In some embodiments, the system sends vendor results in step 307. The vendor results can be sent at various stages. In some embodiments the vendor results are only sent once a user has selected a specific property. In other embodiments, the vendor results are sent simultaneous with the property results. Thus, in some embodiments the vendor results are sent and/or display with the property database results. This is helpful to the client, in some embodiments, as a client can view which vendors are available with various properties. One client might want more guidance and assistance which vendors can offer, and therefore may be more interested in properties which have accompanying vendors. Thus, viewing the possible vendors can aid a client in their decision in selecting a specific property.

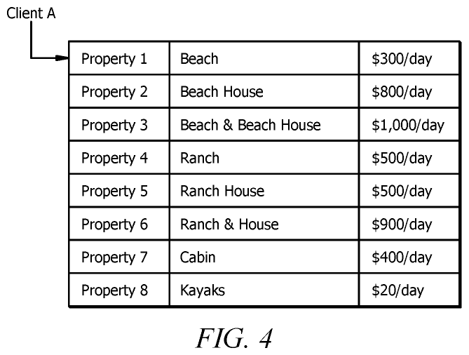

FIG. 4 is a property listing in one embodiment. As can be seen, there are eight different properties in the search relevant to “Client A.” These includes options and pricing for a “beach”, a “beach house” and “the beach and beach house combination.” The way it is priced in the embodiment depicted, the rental client receives a slight discount if they book the beach and beach house as a combination.

FIG. 4 also demonstrates the options of a “ranch”, “ranch house” or “ranch plus house.” Property 7 is a cabin by itself, and Property 8 includes kayaks. The properties 1-8 may be owned by the same individual or entity, or they may be owned by different individuals or entities. It is likely that one entity owns properties 1-3, and that a separate entity owns properties 4-6. Likewise, it is possible that properties 7 and 8 share an owner, while it is possible they do not share an owner. It is possible, for example, that property 8 only offers a kayak, whereas it is also possible that the same owner that owns properties 1-3 also owns property 8.

The property listing shows the property name, a brief description, and cost. However, this is for illustrative purposes only and should not be deemed limiting. The listing can also include photographs, date availability, reviews from previous renters, etc. Also, as previously described, the listing can also include vendor information relevant to specific properties.

The property listing can take virtually any form or format. While one example shows a table, this is for illustrative purposes only. In other embodiments, for example, the listings will be displayed on a map. This gives the rental client an opportunity to see where the various properties are located. In some embodiments when the user highlights the property, or otherwise selects the property, on the map more detailed property information is given. As previously noted, the client interface can take place on a website or a specific application running on a client device.

In one embodiment the property listing is customizable by the client. The client can filter what information and how that information is displayed.

As noted, after reviewing and researching the property listing, the rental client can modify the search, or they can make a selection. If they make a selection they can either proceed to reservations, or they can be presented with vendor information. As noted previously, the vendor listing information can be presented at virtually any stage in the process described herein.

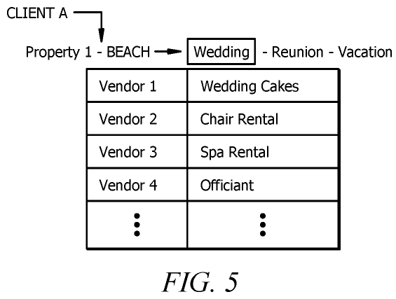

Turning to FIG. 5, FIG. 5 is a vendor listing in one embodiment. In this embodiment depicted, the vendor list is selected after the property is selected. In one embodiment, at some point in the process, the rental client is provided the optional opportunity to describe or select the event type. In the embodiment depicted, after the rental client has selected the property, they are prompted to select an event type. In this embodiment, the user selected “Wedding.”

Selecting specific event types allows the system to customize the vendors which pertain to a specific property and event type. As shown, the vendors in FIG. 5 all relate to weddings: wedding cakes, chair rentals, spa rentals, officiant vendors, etc. This optimizes the relevance of the vendors and increases the likelihood that the client will select one of the vendors. As an example, if a “wedding” is selected as the event, and the wedding takes place at a beach, it is very unlikely that the rental client will need information on winter skiing boots. Thus, the system and vendor database takes several factors into consideration when providing potential vendors on the vending list.

The system can also utilize the property and event location in determining which vendors to list. If the property is located in Florida, it is unlikely they will need a rafting guide based on Colorado.

The system, as mentioned above, can also use the posting client's preference in deciding which vendors to highlight. As noted, if a posting client has a preference for specific tour guides, hunting guides, caterers, etc., then than can also determine which vendors are selected.

In some embodiments the system also utilizes a ranking system based, in part, on the reviews of the vendors. If a first caterer in a given location has 5 star reviews from previous users and a second caterer in the same location has a 1 star review, the system can list the second caterer below the first.

In some embodiments the rental client is given the opportunity to book or reserve the properties and vendors simultaneously. In these embodiments, it allows the client the chance to make a single payment, down-payment, etc., in a single transaction. In other embodiments, the client cannot book the vendor, but is instead given information on the vendor to book them separately.

Once the client reserves the property, properties, and/or vendor, they will receive additional information which is pertinent to that property or vendor. For example, they will receive information on the key pad to the lock, where the boat keys are stored, etc. They will also receive information on the land-specific properties such as where does the public beach begin, where is the private beach, information about public right-of-way, etc.

In some embodiments the system takes payment via either the website or the application and distributes the funds to the property owners or vendors. In other embodiments, the vendors or property owners are paid directly with a portion of the funds being remitted back to the system.

The system and method discussed herein has several benefits and advantages. First, the system discussed herein provides a variety of revenue generating streams for the system. The system can charge the property owner for hosting the properties. The system can also charge a fee or percentage of each property reserved with the system. One skilled in the art will understand the various ways to structure and split payment between the system and the property owner.

An additional revenue stream is advertising. As noted, property owners can choose to pay for hosting or advertising services. Additionally, vendors can pay for advertising. Knowing the event, location, and date, the system allows for targeting advertising for vendors who will pay for the opportunity for such targeting advertisement. Thus, if a wedding is selected, various vendors will advertise their wedding-related services or goods on the website or the application which can be presented to the potential rental client.

Additionally, vendors can pay for the ability to be listed as a vendor. Rather than, or in addition to, advertising, vendors can pay to be a listed vendor. Additionally, the system can receive a fee or a share of the revenue obtained from the vendor, as previously described.

Another advantage is the ability to offer property owners the ability to monetize underused assets. As previously noted, if a rental client is only interested in a beach, the client is not going to rent an entire beach house. The owner of that beach house lost out on possible revenue. However, by extending the renting capability to encompass non-traditional renting properties, such as the beach, the owner increases the number of assets available for rent, and accordingly increases the renting opportunity pool.

Many property owners purchase properties, such as a vacation homes, to generate revenue. An empty property does not generate revenue, and in fact, is an expense. Property associated fees such as utilities, mortgages, taxes, HOA fees, continue whether the property is being rented or not. Thus, even if the property owner would rather rent the entire beach house, for example, renting only the beach is still revenue which was previously unavailable. In some circumstances, the owner will be able to offset, recover, or more than offset the expenses of the property simply by renting out a portion of the larger property options available. Thus, the system and method provide a property owner the opportunity to segment the property and monetize an asset which would have otherwise sat unused. This is true with both real and tangible property. As noted, the bass boat, for example, may sit unused but with the segmenting, renting the bass boat alone can provide revenue to the property owner.

Another advantage is increased exposure. A potential rental client may only be interested, initially, in renting the beach. However, when reviewing the beach property the client decides they want to also rent the beach house. Thus, the smaller segmented revenue can lead to larger revenue in the future that would never have been realized.

Further, when exposure to potential events is increased, the down-the-line organic exposure is also increased. Consider a wedding which takes place at a property owner's beach, but not the beach house. Pictures from that wedding are likely to be shared on social media, and others will inquire as to where the wedding took place. Thus, by simply renting the beach, even though revenue from the house was not realized with that particular event, the exposure generated from renting the beach will likely turn into other downstream opportunities.

An additional benefit is the ability to couple rental clients with vendors. The rental client is provided location and, often, event specific vendors. As noted, the ability to suggest specific vendors depending upon the type of the event is a significant benefit to the rental client. Often, the rental client will be able to reserve not only the venue, but other services and vendors necessary for the event on the same website or application.

While the invention has been particularly shown and described with reference to a preferred embodiment, it will be understood by those skilled in the art that various changes in form and detail may be made therein without departing from the spirit and scope of the invention.

What is claimed is:

1. A system for monetizing an asset, said system comprising:
a first property owner comprising at least two segmented properties;
a property database housing information related to said two segmented properties owned by said first property owner;
a server in communication with said property database and a plurality of client devices;
wherein a client can reserve one or more of said segmented properties from said client devices.
